(19) United States
(12) Patent Application Publication
(10) Pub. No.: US 2023/0183469 A1
(43) Pub. Date: Jun. 15, 2023

(54) POLYOLEFIN/(METH)ACRYLIC COMPOSITE POLYMER COMPOSITION AND METHOD OF PREPARING SAME

(71) Applicants: Rohm and Haas Company, Collegeville, PA (US); Dow Global Technologies LLC, Midland, MI (US)

(72) Inventors: Pu Luo, King Of Prussia, PA (US); Steven C. Brown, Elverson, PA (US); Matthew Carter, Bala Cynwyd, PA (US); Liang Chen, Sewickley, PA (US); Ralph C. Even, Blue Bell, PA (US); Junsi Gu, Malvern, PA (US); Miroslav Janco, Collegeville, PA (US); Robert S. Moglia, Midland, MI (US); Johnpeter N. Ngunjiri, Gilbertsville, PA (US); Tanvi S. Ratani, Pittsburgh, PA (US)

(21) Appl. No.: 17/924,263

(22) PCT Filed: Jun. 17, 2021
(86) PCT No.: PCT/US2021/037729

§ 371 Date: Nov. 9, 2022

Related U.S. Application Data
(60) Provisional application No. 63/041,248, filed on Jun. 19, 2020.

(51) Int. Cl. C08L 51/06; C08F 6/22; C08F 255/02; C08L 69/00

(52) U.S. Cl. CPC C08L 51/06; C08F 6/22; C08F 255/02; C08L 69/00; C08L 2207/53; C08L 2201/50

(57) ABSTRACT

A composite polymer composition comprising: the emulsion polymerization product of: (i) an aqueous polyolefin dispersion comprising the melt kneading product of one or more polyolefins, from 0.5 to 25 wt % of one or more dispersion stabilizing agents and water, and (ii) one or more (meth)acrylic monomers; wherein the one or more polyolefins have a Tg equal to or less than 50° C.; wherein the melt kneading product (i) comprises polymer particles having a volume average particle size between 50 nm and 2000 nm dispersed in the water; wherein the one or more dispersion stabilizing agents comprises a fatty acid or fatty acid salt stabilizing agent; and wherein the one or more (meth)acrylic monomers graft onto the polymer particles form composite polymer particles is provide. Also provided is a method of making the composition and impact modifiers comprising the composition.

### FIELD OF INVENTION

The present invention relates to polyolefin/(meth)acrylic composite polymer compositions and methods of preparing the same.

### BACKGROUND OF THE INVENTION

Many widely-used polymer resins, such as polycarbonate, display good impact performance properties under ambient conditions, but this property significantly deteriorates below room temperature, resulting in undesirable cracking or physical breakage of the resin. The use of so-called impact modifier additives assists in maintaining the desirable impact properties of the polymer resin at lower temperatures.

For certain applications, such as the impact modification of polymer resins used in automotive, electronic, and durable goods, there exists a market need to improve polymer resin properties such as the low temperature impact performance without negatively affecting polymer resin weathering.

One effective type of impact modifiers is colloidally-stable polymer particles that are on the order of 50-500 nm in diameter, prepared by an emulsion polymerization process. These polymer particles display a core-shell morphology, where the core is comprised of up to approximately 95 wt % of a lower glass transition temperature (Tg) (co)polymer, and the shell is comprised of a higher Tg (co)polymer. The presence of the higher Tg shell prevents the lower Tg cores of the particles from agglomerating substantially when the particles are dried into powder; powdering of the latex is typically performed to enable further polymer particle processing (i.e., for dispersion into a polymer resin). Additionally, the higher Tg shell aids in compatibilizing the polymer particle core with the desired host polymer resin, or matrix, material. Without the shell, the effectiveness of the impact modifiers is significantly limited.

Impact modifier compositions prepared with a low Tg poly(butadiene) core generally yield excellent low temperature impact performance when these polymer particles are dispersed in a variety of resins. However, the weatherability of these composite materials is typically unsatisfactory, because olefin-containing groups present in the impact modifier particles compounded in the polymer resin can crosslink or undergo other reactions, causing degradation and the composite material to become brittle. For polymer resins containing impact modifier compositions prepared with a low Tg poly(butyl acrylate)-containing core, the weatherability is generally excellent, however the low temperature impact performance is generally average. As a result, the development of a new class of impact modifier that simultaneously provides both excellent impact performance at low temperatures and desirable weatherability in a host resin would represent a significant advance in the field and fulfill an unmet need in the art.

Thus far, the processes available to prepare core-shell impact modifiers in the desirable size range of 50-500 nm in diameter were limited to monomers that could be polymerized by emulsion polymerization. It has not previously been possible to fabricate impact modifier particles using other chemistries. For example, olefins and olefin copolymers could serve as the core because these compositions are known to be effective impact modifiers due to their low Tg, elastomeric properties, and good weatherability. However, olefin copolymers alone do not generally disperse well within a host resin. Moreover, no route exists to make dispersed core-shell particles (with olefin copolymer cores) within the required size range of 50-200 nm in diameter and also comprising a compatibilizing phase within a multi-domain structure (for example, core-shell or composite morphologies).

Hybrid polyolefin-acrylic (POA) particles comprising a low Tg polyolefin-based core and a high Tg PMMA-based phase have been prepared, as disclosed by Carter et al., “Design and Fabrication of Polyolefin-Acrylic Hybrid Latex Particles” ACS Appl. Polym. Mater. 2019, 1, 3185-3195. These hybrid POA particles, however, display a low grafting efficiency, which is a measure of the extent to which the acrylic polymer is strongly associated with the polyolefin core. Even with optimization of the process, the highest grafting efficiency Carter et al. observed was <60%.

There is a need for composite polyolefin-acrylic compositions having a higher grafting efficiency. It is also desirable to provide composite polyolefin-acrylic compositions that display good performance properties, such as weatherability and low temperature impact performance, when used within a host polymer resin or matrix.

### SUMMARY OF THE INVENTION

The present invention relates to a polyolefin/(meth)acrylic composite polymer composition, an impact modifier comprising the composite polymer composition, and method of preparing the same.

One aspect of the invention provides a composite polymer composition comprising the emulsion polymerization product of: (i) an aqueous polyolefin dispersion comprising the melt kneading product of one or more polyolefins, from 0.5 to 25 wt % of one or more dispersion stabilizing agents, water, and optionally a neutralizing agent, and (ii) one or more (meth)acrylic monomers; wherein the one or more polyolefins have a Tg equal to or less than 50° C.; wherein the melt kneading product (i) comprises polymer particles having a volume average particle size from 50 nm to 2000 nm dispersed in the water; wherein the one or more dispersion stabilizing agents comprises a fatty acid or fatty acid salt stabilizing agent; and wherein the one or more (meth)acrylic monomers graft onto the polymer particles to form composite polymer particles.

Another aspect of the invention provides an impact modifier composition comprising the dried product of a polymer composition comprising: the emulsion polymerization product of: (i) an aqueous polyolefin dispersion comprising the melt kneading product of one or more polyolefins, from 0.5 to 25 wt % of one or more dispersion stabilizing agents, water, and optionally a neutralizing agent, and (ii) one or more (meth)acrylic monomers; wherein the one or more polyolefins have a Tg of equal to or less than 50° C.; wherein the melt kneading product (i) comprises polymer particles having a volume average particle size from 50 nm to 2000 nm dispersed in the water; wherein the one or more dispersion stabilizing agents comprises a fatty acid or fatty acid salt stabilizing agent; and wherein the one or more (meth)acrylic monomers graft onto the polymer particles to form composite polymer particles.

Yet another aspect of the invention provides an impact modifier-containing resin, hereafter referred to as an impact modified resin, comprising a matrix polymer resin and an impact modifier composition comprising a dried product of a polymer composition comprising the emulsion polymerization product of: (i) an aqueous polyolefin dispersion comprising the melt kneading product of one or more polyolefins, from 0.5 to 25 wt % of one or more dispersion stabilizing agents, water and optionally a neutralizing agent, and (ii) one or more (meth)acrylic monomers; wherein the one or more polyolefins have a Tg of equal to or less than 50° C.; wherein the melt kneading product (i) comprises polymer particles having a volume average particle size from 50 nm to 2000 nm dispersed in the water; wherein the one or more dispersion stabilizing agents comprises fatty acid or fatty acid salt stabilizing agent; and wherein the one or more (meth)acrylic monomers graft onto the polymer particles to form composite polymer particles.

A further aspect of the invention provides a method for fabricating an impact modifier composition comprising the following: melt kneading one or more polyolefins, one or more dispersion stabilizing agents, water, and optionally a neutralizing agent, wherein the one or more polyolefins have a Tg of equal to or less than 50° C., and wherein the one or more dispersion stabilizing agents comprise a fatty acid or fatty acid salt stabilizing agent; adding to the melt kneading product one or more (meth)acrylic monomers under emulsion polymerization conditions to form a composite polymer composition; and isolating the composite polymer particles by removing water from the polymer particle dispersion, wherein the isolation method is selected from the group consisting of spray drying, coagulation, and freeze drying.

### DETAILED DESCRIPTION OF THE INVENTION

The present invention relates to a polyolefin/(meth)acrylic composite polymer compositions prepared with a fatty acid or fatty acid salt stabilizing agent, method of preparing the same.

The composite polymer composition according to the present invention comprises the emulsion polymerization product of: (i) an aqueous polyolefin dispersion comprising the melt kneading product of one or more polyolefins, from 0.5 to 25 wt % of one or more dispersion stabilizing agents and water, and (ii) one or more (meth)acrylic monomers; wherein the one or more polyolefins have a Tg equal to or less than 50° C.; wherein the melt kneading product (i) comprises polymer particles having a volume average particle size from 50 nm to 2000 nm dispersed in the water; wherein the one or more dispersion stabilizing agents comprises a fatty acid or fatty acid salt stabilizing agent; and wherein the one or more (meth)acrylic monomers graft onto the polymer particles to form composite polymer particles.

The present invention further provides an impact modifier composition comprising a dried product of the composite polymer composition according to any of the embodiments disclosed herein.

The present invention also provides an impact modified resin comprising a matrix polymer resin, and the impact modifier composition according to any of the embodiments disclosed herein.

The present invention still further provides a method for forming an impact modifier composition comprising: melt kneading one or more polyolefins, less than or equal to one or more dispersion stabilizing agents and water, wherein the one or more polyolefins have a Tg of equal to or less than 50° C. and wherein the one or more dispersion stabilizing agents comprise fatty acid or fatty acid salt stabilizing agent; adding to the melt kneading product one or more (meth)acrylic monomers under emulsion polymerization conditions to form a composite polymer composition; and isolating the composite polymer particles by removing water from the emulsion wherein the isolation process is selected from the group consisting of spray drying, coagulation and freeze drying.

### Aqueous Polyolefin Dispersion

### Polyolefin

The aqueous dispersion comprises from 5 to 99 wt % of one or more polyolefins, based on the total weight of the solid content of the aqueous dispersion. All individual values and subranges from 5 to 99 wt % are included herein and disclosed herein; for example, the weight percent can be from a lower limit of 5, 8, 10, 15, 20, 25 wt % to an upper limit of 40, 50, 60, 70, 80, 90, 95, or 99 wt %. For example, the aqueous dispersion may comprise from 15 to 99, or from 15 to 90, or 15 to 80, or from 15 to 75, or from 30 to 70, or from 35 to 65 wt % of one or more polyolefins, based on the total weight of the solid content of the aqueous dispersion. The aqueous dispersion comprises at least one or more polyolefins.

The polyolefins used in the invention have a Tg less than or equal to 50° C. When more than one polyolefin is used, preferably each polyolefin has a Tg less than or equal to 50° C. All individual values and subranges equal to or less than 50° C. are disclosed herein and included herein. For example, the Tg may be equal to or less than 50° C., or in the alternative, the Tg may be equal to or less than 40° C., or in the alternative, the Tg may be equal to or less than 30° C., or in the alternative, the Tg may be equal to or less than 15° C., or in the alternative, the Tg may be equal to or less than 0° C., or in the alternative, the Tg may be equal to or less than −15° C. Preferably, the polyolefins have a Tg equal to or less than −50° C.

Examples of polyolefins include, but are not limited to, homopolymers and copolymers (including elastomers) of one or more alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer. These resins may be used either alone or in combinations of two or more.

The polyolefin may, for example, comprise one or more polyolefins selected from the group consisting of ethylene/alpha-olefin copolymers, propylene/alpha-olefin copolymers, and olefin block copolymers. In particular, the polyolefin may comprise one or more non-polar polyolefins.

Polyolefins such as polypropylene, polyethylene, copolymers thereof, and blends thereof, as well as ethylene-propylene-diene terpolymers, may be used. Exemplary olefinic polymers include homogeneous polymers, as described in U.S. Pat. No. 3,645,992; high density polyethylene (HDPE), as described in U.S. Pat. No. 4,076,698; heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers, which can be prepared, for example, by processes disclosed in U.S. Pat. Nos. 5,272,236 and 5,278,272, the disclosures of which are incorporated herein by reference; and high pressure, free radical polymerized ethylene polymers and copolymers such as low density polyethylene (LDPE) or ethylene vinyl acetate polymers (EVA). The polyolefin may, for example, be ethylene-methyl acrylate (EMA) based polymers.

Preferably, the polyolefin may be an ethylene/alpha-olefin copolymer. Polyethylene-alpha olefin copolymers comprise units derived from ethylene and polymeric units derived from one or more alpha-olefin. Exemplary polymeric units derived from one or more alpha-olefin include, for example, C₂ and C₄ to C₁₀ alpha-olefins, preferably C₂, C₄, C₆, and C₈ alpha olefins. Examples of polyethylene/alpha-olefin copolymers include, for example, ethylene-butene, ethylene-hexene, or ethylene-octene copolymers or interpolymers.

The polyolefin may comprise a propylene/alpha-olefin copolymer. The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins. Propylene/alpha-olefin copolymers include, for example, propylene-ethylene or a propylene-ethylene-butene copolymer or interpolymer. The propylene/alpha-olefin copolymer may be characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra.

The polyolefin may have a melt flow rate in the range of from 1 to 1500 g/10 minutes, measured in accordance with ASTM D-1238 (at 190° C./2.16 Kg). All individual values and subranges from 1 to 1500 g/10 minutes are included herein and disclosed herein; for example, the melt flow rate can be from a lower limit of 1 g/10 minutes, 2 g/10 minutes, 3 g/10 minutes, 4 g/10 minutes, 5 g/10 minutes 100 g/10 minutes, 200 g/10 minutes, 500 g/10 minutes, 800 g/10 minutes, 1000 g/10 minutes, 1300 g/10 minutes; or 1400 g/10 minutes to an upper limit of 1500 g/10 minutes, 1250 g/10 minutes, 1000 g/10 minutes, 800 g/10 minutes, 500 g/10 minutes, 100 g/10 minutes, 50 g/10 minutes, 40 g/10 minutes, and 30 g/10 minutes. For example, the propylene/alpha-olefin copolymer may have a melt flow rate in the range of from 1 to 1500 g/10 minutes; or from 1 to 500 g/10 minutes; or from 500 to 1500 g/10 minutes; or from 500 to 1250 g/10 minutes; or from 300 to 1300 g/10 minutes; or from 5 to 30 g/10 minutes.

The polyolefin may have a molecular weight distribution (MWD), defined as weight average molecular weight divided by number average molecular weight (M_{w}/Mₙ), of 3.5 or less; in the alternative 3.0 or less; or in another alternative from 1.8 to 3.0.

Such polyolefins are commercially available from The Dow Chemical Company, under the tradename VERSIFY™ Plastomers and Elastomers and ENGAGE™ Polyolefin Elastomer, or from ExxonMobil Chemical Company, under the tradename VISTAMAXX™ and EXACT™.

The polyolefin may also comprise olefin block copolymers, e.g., ethylene multi-block copolymer, such as those described in the International Publication No. WO2005/090427 and U.S. Patent Application Publication No. US 2006/0199930, incorporated herein by reference to the extent describing such olefin block copolymers, may be used as the polyolefin. Such olefin block copolymer may be an ethylene/α-olefin interpolymer:

(a) having a M_{w}/Mₙ from about 1.7 to about 3.5, at least one melting point, Tₘ, in degrees Celsius, and a density, d, in grams/cubic centimeter, wherein the numerical values of Tₘ and d corresponding to the relationship:

Tₘ>−2002.9+4538.5(d)−2422.2(d)²; or

(b) having a M_{w}/Mₙ from about 1.7 to about 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≥48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or

(c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481−1629(d); or

(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′ (25° C.) to G′ (100° C.) being in the range of about 1:1 to about 9:1.

Such olefin block copolymer, e.g. ethylene/α-olefin interpolymer may also:

(a) have a molecular fraction which elutes between 40° C. and 130° C. when fractionated using TREF, characterized in that the fraction having a block index of at least 0.5 and up to about 1 and a molecular weight distribution, M_{w}/Mₙ, greater than about 1.3; or

(b) have an average block index greater than zero and up to about 1.0 and a molecular weight distribution, M_{w}/Mₙ, greater than about 1.3.

The polyolefin may, for example, comprise one or more polar polyolefins, having a polar group as either a comonomer or grafted monomer. Exemplary polar polyolefins include, but are not limited to, ethylene-acrylic acid (EAA) and ethylene-methacrylic acid copolymers, such as those available under the trademarks PRIMACOR™, commercially available from The Dow Chemical Company, NUCREL™, commercially available from E.I. DuPont de Nemours, and ESCOR™, commercially available from ExxonMobil Chemical Company and described in U.S. Pat. Nos. 4,599,392, 4,988,781, and 5,938,437, each of which is incorporated herein by reference in its entirety. Other exemplary base polymers include, but are not limited to, ethylene ethyl acrylate (EEA) copolymer, ethylene methyl methacrylate (EMMA), and ethylene butyl acrylate (EBA).

Polar polyolefins may be selected from the group consisting of ethylene-acrylic acid (EAA) copolymer, ethylene-methacrylic acid copolymer, and combinations thereof, and the stabilizing agent may, for example, comprise a polar polyolefin selected from the group consisting of ethylene-acrylic acid (EAA) copolymer, ethylene-methacrylic acid copolymer, and combinations thereof; provided, however, that base polymer may, for example, have a lower acid number, measured according to ASTM D-974, than the stabilizing agent.

### Stabilizing Agent

The aqueous dispersion further comprises at least one or more stabilizing agents, also referred to herein as dispersion agents, to promote the formation of a stable dispersion. The stabilizing agent may preferably be an external stabilizing agent. The aqueous dispersion comprises 0.5 to 25 wt % of one or more stabilizing agents, based on the total weight of the solid content of the dispersion. All individual values and subranges from 0.5 to 25 wt % are included herein and disclosed herein; for example, the weight percent can be from a lower limit of 0.5, 1, 2, 5, 7, 9, 11, 14, 19 or 24 wt % to an upper limit of 4, 6, 8, 10, 15, 20 or 25 wt %. For example, the dispersion may comprise from 0.5 to 25 wt %, or in the alternative from 1 to 5 wt %, or in the alternative from 3 to 10 wt %, or in the alternative from 2 to 8 wt %, or in the alternative from 5 to 20 wt %, or in the alternative from 10 to 20 wt % of one or more stabilizing agents, based on the total weight of the solid content of the dispersion.

The one or more stabilizing agents comprises a fatty acid or fatty acid salt stabilizing agent. As used herein, the term “fatty acid” means a carboxylic acid having a saturated or unsaturated hydrocarbon chain and a terminal carboxyl group. When the fatty acid is unsaturated, the fatty acid may be any enantiomer. Preferably, the fatty acid or fatty acid salt stabilizing agent is present in an amount ranging from 1 to 6 wt %, and more preferably from 1.5 to 5 wt %, based on the total weight of the solid content of the dispersion. When the fatty acid or fatty acid salt stabilizing agent is present in larger amounts, it may become more difficult for (meth)acrylic polymers to graft on the polyolefin. If the fatty acid or fatty acid salt stabilizing agent is present in smaller amounts, the particle size may get too large and/or the grafting efficiency may decrease.

The fatty acid or fatty acid salt stabilizing agent comprises 4 to 60 carbon atoms. Preferably, the fatty acid or fatty acid salt stabilizing agent comprises at least 8 carbon atoms, more preferably at least 10 carbon atoms, still more preferably at least 12 carbon atoms, and yet more preferably at least 14 carbon atoms. Preferably, the fatty acid or fatty acid salt stabilizing agent comprises at most 40 carbon atoms, more preferably at most 30 carbon atoms, and even more preferably at most 24 carbon atoms.

Preferably, the fatty acid or fatty acid salt comprises 16, 18, or 20 carbon atoms. More preferably, the fatty acid or fatty acid salt comprises 18 carbon atoms and may be selected from stearic acid, oleic acid, and linoleic acid, and salts thereof.

Examples of salts of oleic acid that may be used include a potassium salt of oleic acid (e.g., OPK-181 available from RTD Hallstar), a sodium salt of oleic acid, or an ammonium salt of oleic acid.

It has been surprisingly discovered that using fatty acid or fatty acid salt stabilizing agents significantly increases the grafting efficiency of the acrylic polymer to the polyolefin core. The grafting efficiency of the acrylic shell onto the olefin core in the composite polymer the present invention, as measured according to the process described below, is greater than or equal to 75%. Preferably, the grafting efficiency of the composite polymer composition is greater than or equal to 80% and more preferably at least 85%. The grafting efficiency of the composite polymer composition may be greater than 90%. In addition to the grafting efficiency, the fatty acid or fatty acid salt stabilizing agent can provide composite polymer particles in a polyolefin dispersion having a small particle size, i.e., a particle size less than or equal to 2000 nm.

The one or more stabilizing agents may comprise a mixture of two or more stabilizing agents. For example, the one or more stabilizing agents may comprise a non-fatty acid or fatty acid salt stabilizing agent in addition to the oleate surfactant.

The additional stabilizing agent may be a surfactant, a polymer, or mixtures thereof. The additional stabilizing agent can be a polar polymer, having a polar group as either a comonomer or grafted monomer. For example, the additional stabilizing agent may comprise one or more polar polyolefins, having a polar group as either a comonomer or grafted monomer. Exemplary polymeric stabilizing agents include, but are not limited to, ethylene-acrylic acid (EAA) and ethylene-methacrylic acid copolymers, such as those available under the trademarks PRIMACOR, commercially available from The Dow Chemical Company, NUCREL, commercially available from E.I. DuPont de Nemours, and ESCOR, commercially available from ExxonMobil Chemical Company and described in U.S. Pat. Nos. 4,599,392, 4,988,781, and 5,938,437, each of which is incorporated herein by reference in its entirety. Other exemplary polymeric stabilizing agents include, but are not limited to, ethylene ethyl acrylate (EEA) copolymer, ethylene methyl methacrylate (EMMA), and ethylene butyl acrylate (EBA). Other ethylene-carboxylic acid copolymer may also be used. Those having ordinary skill in the art will recognize that a number of other useful polymers may also be used.

The additional stabilizing agent that may be used may include, but is not limited to, long chain fatty acids, fatty acid salts, or fatty acid alkyl esters having from 12 to 60 carbon atoms. Preferably, the long chain fatty acid or fatty acid salt may have from 12 to 40 carbon atoms.

Other examples of additional stabilizing agents that may be useful in the practice of the present invention include, but are not limited to, cationic surfactants, anionic surfactants, or non-ionic surfactants. Examples of anionic surfactants include, but are not limited to, sulfonates, carboxylates, and phosphates. Examples of cationic surfactants include, but are not limited to, quaternary amines Examples of non-ionic surfactants include, but are not limited to, block copolymers containing ethylene oxide and silicone surfactants.

The additional stabilizing agents can be either external surfactants or internal surfactants. External surfactants are surfactants that do not become chemically reacted into the polyolefin during dispersion preparation. Examples of external surfactants useful herein include, but are not limited to, salts of dodecyl benzene sulfonic acid and lauryl sulfonic acid salt. Internal surfactants are surfactants that do become chemically grafted to the polyolefin during dispersion preparation. An example of an internal surfactant useful herein includes 2,2-dimethylol propionic acid and its salts. Various commercially-available surfactants may be used, including: OP-100 (a sodium stearate) and OPK-1000 (a potassium stearate), each available from RTD Hallstar; UNICID 350, available from Baker Petrolite; DISPONIL FES 77-IS and DISPONIL TA-430, each available from Cognis; RHODAPEX CO-436, SOPROPHOR 4D384, 3D-33, and 796/P, RHODACAL BX-78 and LDS-22, RHODAFAC RE-610, and RM-710, and SUPRAGIL MNS/90, each available from Rhodia; and TRITON QS-15, TRITON W-30, DOWFAX 2A1, DOWFAX 3B2, DOWFAX 8390, DOWFAX C6L, TRITON X-200, TRITON XN-45S, TRITON H-55, TRITON GR-5M, TRITON BG-10, and TRITON CG-110, each available from The Dow Chemical Company.

The one or more stabilizing agent may comprise, consist of, or consist essentially of a fatty acid or fatty acid salt stabilizing agent. As used herein, the phrase “consist essentially of a fatty acid or fatty acid salt stabilizing agent” means the one or more stabilizing agent comprises less than 5 wt % of any stabilizing agent other than a fatty acid or fatty acid salt stabilizing agent, based on the total weight of the stabilizing agent.

The one or more stabilizing agent may comprise a fatty acid or fatty acid salt stabilizing agent and at least one additional stabilizing agent. When the composite polymer composition comprises fatty acid or fatty acid salt stabilizing agent and an additional stabilizing agent, the fatty acid or fatty acid salt stabilizing agent and the additional stabilizing agent may be present in a weight ratio of 20:1 to 1:20, such as, for example, from 10:1 to 1:10, from 5:1 to 1:5, from 3:1 to 1:3, from 2:1 to 1:2, or 1:1. Preferably, the one or more stabilizing agent comprises an oleic acid salt and a lauryl ether sulfate, such as sodium lauryl ether sulfate.

The one or more stabilizing agent may optionally be partially or fully neutralized with a neutralizing agent. Neutralization of the one or more stabilizing agent may be, for example, from 25 to 200 percent on a molar basis; preferably, it may be from 50 to 175 percent on a molar basis. For example, when the stabilizing agent comprises oleic acid, a salt of oleic acid, or EAA, the neutralizing agent may be a base, such as sodium hydroxide or potassium hydroxide, for example. Other neutralizing agents can include lithium hydroxide or ammonium hydroxide, for example. In another alternative, the neutralizing agent may, for example, be a carbonate or bicarbonate salt. In another alternative, the neutralizing agent may, for example, be any amine such as monoethanolamine, or 2-amino-2-methyl-1-propanol (AMP) Amines useful in embodiments disclosed herein may include monoethanolamine, diethanolamine, triethanolamine, and TRIS AMINO (each available from Angus), NEUTROL TE (available from BASF), as well as triisopropanolamine, diisopropanolamine, and N,N-dimethylethanolamine (each available from The Dow Chemical Company). Other useful amines may include ammonia, monomethylamine, dimethylamine, trimethylamine, monoethylamine, diethylamine, triethylamine, mono-n-propylamine, dimethyl-n propylamine, N-methanol amine, N-aminoethylethanolamine, N-methyldiethanolamine, monoisopropanolamine, N,N-dimethyl propanolamine, 2-amino-2-methyl-1-propanol, tris(hydroxymethyl)-aminomethane, N,N,N′N′-tetrakis(2-hydroxylpropyl) ethylenediamine, 1.2-diaminopropane. Mixtures of amines or mixtures of amines and surfactants may be used. Those having ordinary skill in the art will appreciate that the selection of an appropriate neutralizing agent depends on the specific composition formulated, and that such a choice is within the knowledge of those of ordinary skill in the art.

### Fluid Medium

The dispersion further comprises a fluid medium. The fluid medium may be any medium; for example, the fluid medium may be water. The dispersion of the present invention comprises 35 to 80 percent by volume of fluid medium, based on the total volume of the dispersion. For example, the water content may be in the range of from 35 to 75, or in the alternative from 35 to 70, or in the alternative from 45 to 60 percent by volume, based on the total volume of the dispersion. Water content of the dispersion may preferably be controlled so that the solids content (polyolefin plus stabilizing agent) is between about 1 percent to about 74 percent by volume. The solids range, for example, may be between about 10 percent to about 70 percent by volume, such as between about 20 percent to about 65 percent by volume or between about 25 percent to about 55 percent by volume.

### Additional Components

The aqueous dispersion may further comprise optionally one or more additional components. Examples of additional components include, but are not limited to, crosslinkers, graft-linkers, binder compositions, fillers, pigments, co-solvents, dispersants, surfactants, defoamers, preservatives, thickeners, and neutralizing agents.

Exemplary crosslinking agents include, for example, divinylbenzene; vinyl group-containing monomers including; triallyl (iso)cyanurate (TAIL), and triallyl trimelitate; (poly)alkylene glycol di(meth)acrylate compounds including ethylene glycol dimethacrylate (EGDMA), diethylene glycol dimethacrylate, 1,6-hexanediol di(meth)acrylate, (poly)ethylene glycol di(meth)acrylate, (poly)propylene glycol di(meth)acrylate, (poly)tetramethylene glycol di(meth)acrylate, pentaerythritol tetra(meth)acrylate, pentaerythritol tri(meth)acrylate, pentaerythritol di(meth)acrylate, trimethylolpropane tri(meth)acrylate, dipentaerythritol hexa(meth)acrylate, dipentaerythritol penta(meth)acrylate, and glycerol tri(meth)acrylate and mixtures and combination thereof.

Exemplary graft-linking agents include, but are not limited to, allyl methacrylate, diallyl maleate and allyl acryloxypropionate.

Exemplary binder compositions include, but are not limited to, acrylic latex, vinyl acrylic latex, styrene acrylic latex, vinyl acetate ethylene latex, and combinations thereof.

Exemplary pigments include, but are not limited to, titanium dioxide, mica, calcium carbonate, silica, zinc oxide, milled glass, aluminum trihydrate, talc, antimony trioxide, fly ash, and clay.

Exemplary co-solvents include, but are not limited to, glycols, glycol ether, 2,2,4-trimethyl-1,3-pentanediol monoisobutyrate, alcohols, mineral spirits, and benzoate esters.

Exemplary dispersants include, but are not limited to, aminoalcohols, and polycarboxylates.

Exemplary preservatives include, but are not limited to, biocides, mildewcides, fungicides, algaecides, and combinations thereof.

Exemplary thickeners include, but are not limited to, cellulosic based thickeners such as hydroxyethyl cellulose, hydrophobically modified alkali soluble emulsions (HASE thickeners such as UCAR POLYPHOBE TR-116) and hydrophobically modified ethoxylated urethane thickeners (HEUR).

Exemplary neutralizing agents include, but are not limited to, hydroxides, amines, ammonia, and carbonates.

### Forming the Aqueous Dispersion

The aqueous dispersion can be formed by any number of methods recognized by those having skill in the art. For example, one or more polyolefin, optionally one or more additives, and optionally one or more stabilizing agents are melt-kneaded in an extruder along with water and a neutralizing agent, such as ammonia, potassium hydroxide, or a combination of the two to form a dispersion. In another example, one or more polyolefins and one or more additives are compounded, and then the polyolefin/subparticles compound is melt-kneaded in an extruder in the presence of an optional stabilizing agent, water, and one or more neutralizing agents thereby forming a dispersion. The dispersion may be diluted first to contain about 1 to about 3% by weight water and then, subsequently, further diluted to comprise greater than about 25% by weight water.

Any melt-kneading means known in the art may be used. For example, a kneader, a BANBURY® mixer, single-screw extruder, or a multi-screw extruder, e.g. a twin screw extruder, can be used. A process for producing the dispersions in accordance with the present invention is not particularly limited. For example, an extruder, such as a twin screw extruder, is coupled to a back pressure regulator, melt pump, or gear pump. A base reservoir and an initial water reservoir may also be provided, each of which includes a pump. Desired amounts of base and initial water are provided from the base reservoir and the initial water reservoir, respectively. Any suitable pump may be used, such as, for example, a pump that provides a flow of about 150 cc/min at a pressure of 240 bar is used to provide the base and the initial water to the extruder, such as a flow of 300 cc/min at 200 bar or 600 cc/min at 133 bar. The base and initial water can be preheated in a preheater.

One or more polyolefins, in the form of pellets, powder, or flakes, are fed from the feeder to an inlet of the extruder where the resin is melted or compounded. One or more additives may be fed simultaneously with one or more polyolefins into the extruder via the feeder; or in the alternative, one or more additives may be compounded into one or more polyolefins, and then fed into the extruder via the feeder. In the alternative, additional one or more additives may further be metered via an inlet prior to the emulsification zone into the molten compound comprising one or more polyolefins and optionally one or more additives. The dispersing agent may be added to one or more polyolefins through and along with the resin and in other examples, the dispersing agent is provided separately to the twin screw extruder. The resin melt is then delivered from the mix and convey zone of the extruder to an emulsification zone where the initial amount of water and base from the water and base reservoirs are added through an inlet. Additional dispersing agent may be added to the water stream. The dispersing agent may be added exclusively to the water stream. Further dilution water may be added via the water inlet from the water reservoir in either the dilution and/or cooling zone of the extruder. Typically, the dispersion is diluted to approximately 40 wt % solids in the cooling zone. In addition, the diluted mixture may be diluted any number of times until the desired dilution level is achieved. Alternatively, water is not added into the extruder but rather to a stream containing the resin melt after the melt has exited the extruder. In this manner, steam pressure build-up in the extruder is eliminated and the dispersion is formed in a secondary mixing device such as a rotor stator mixer.

Preferably, the pH of the aqueous dispersion is at least 9.

The melt kneading product comprises polymer particles having a volume average particle size from 50 nm to 2000 nm dispersed in water. All values and subranges from 50 nm to 2000 nm are included herein and disclosed herein; for example the particle size may range from a lower limit of 150, 350, 550, 750, 950, 1150, 1350, 1550, 1750 or 1950 nm to an upper limit of 200, 400, 600, 800, 1000, 1200, 1400, 1600, 1800 or 2000 nm. Preferably, the polymer particles have a volume average particle size greater than or equal to 50 nm and less than or equal to 1000 nm, more preferably greater than or equal to 100 nm and less than or equal to 800 nm, and even more preferably greater than or equal to 150 nm and less than or equal to 600 nm.

(Meth)Acrylic Monomers

As used herein, the term “(meth)acrylic” means acrylic or methacrylic.

(Meth)acrylic monomers used herein include, by way of example, C1-C18 (meth)acrylates, such as, butyl acrylate, ethyl acrylate, 2-ethyl hexyl acrylate, propyl acrylate, methyl acrylate, hexyl acrylate, butylmethacrylate, methylmethacrylate, ethylhexyl methacrylate, stearyl acrylate, benzyl acrylate, cyclohexyl methacrylate, isobornyl methacrylate, tetrahydrofurfuryl methacrylate, cyclopentyl methacrylate, trifluoroethylmethacrylate, hydroxyethylmethacrylate and dicyclopentadienyl methacrylate and blends thereof, and combinations thereof.

The (meth)acrylic monomers may be functionalized, non-functionalized or a combination thereof.

Exemplary functionalized (meth)acrylic monomers include but not limited to, acrylic acid, methacrylic acid, glycidyl methacrylate, allyl methacrylate, hydroxyethyl methacrylate, and acrylamide.

### Emulsion Polymerization

Emulsion polymerization conditions are well known in the art. Emulsion polymerization processes typically utilize one or more surfactants. Optionally, exemplary surfactants include, for example, sodium dodecyl benzene sulfonate or sodium lauryl ether sulfate

One or more crosslinking and/or graft-linking agents may optionally be added to the emulsion polymerization. Exemplary crosslinking agents include, for example, divinylbenzene; vinyl group-containing monomers including; triallyl (iso)cyanurate (TAIL), and triallyl trimelitate; (poly)alkylene glycol di(meth)acrylate compounds including ethylene glycol dimethacrylate (EGDMA), diethylene glycol dimethacrylate, 1,6-hexanediol di(meth)acrylate, (poly)ethylene glycol di(meth)acrylate, (poly)propylene glycol di(meth) acrylate, (poly)tetramethylene glycol di(meth)acrylate, pentaerythritol tetra(meth)acrylate, pentaerythritol tri(meth)acrylate, pentaerythritol di(meth)acrylate, trimethylolpropane tri(meth)acrylate, dipentaerythritol hexa(meth)acrylate, dipentaerythritol penta(meth)acrylate, and glycerol tri(meth)acrylate and mixtures and combination thereof.

Exemplary graft-linking agents include, for example, allyl methacrylate, diallyl maleate and allyl acryloxypropionate.

The present invention also provides a composite polymer composition, impact modifier, impact modified resin, and method of making an impact modifier, in accordance with any of the embodiments disclosed herein, except that the one or more polyolefins are selected from the group consisting of ethylene homopolymers, ethylene/alpha-olefin copolymers, ethylene/alpha-olefin multiblock interpolymers, propylene homopolymers, propylene/alpha-olefin copolymers and propylene/alpha-olefin multiblock interpolymers.

The present invention alternatively provides a composite polymer composition, impact modifier, impact modified resin, and method of making an impact modifier, in accordance with any of the embodiments disclosed herein, except that the one or more (meth)acrylic monomers are selected from the group consisting of functionalized and non-functionalized (meth)acrylic monomers.

The present invention also provides a core/shell polymer composition, impact modifier, impact modified resin, and method of making an impact modifier, in accordance with any of the embodiments disclosed herein, except that the one or more vinyl monomers selected from the group consisting of (meth)acrylates, alkyl/aryl (meth)acrylates, functionalized alkyl(meth)acrylates, functionalized and non-functionalized styrene, acrylonitrile, butadiene, chloroprene, vinyl chloride, vinyl acetate, and combinations of two or more thereof.

the present invention further provides a composite polymer composition, impact modifier, impact modified resin, and method of making an impact modifier, in accordance with any of the embodiments disclosed herein, except that the emulsion polymerization is carried out in the presence of one or more crosslinking and/or graft-linking agents.

The present invention also provides an impact modified resin according to any of the embodiments disclosed herein except that the matrix polymer resin is selected from the group consisting of polycarbonate (PC) and PC blends, polyesters [such as, polybutylene terephthalate/polyethylene terephthalate (PBT/PET) and polylactic acid], polystyrene (PS), styrenic copolymers [such as, acrylonitrile butadiene styrenes (ABS) and styrene-acrylonitrile resin (SAN)], polyvinylchloride (PVC), polyamides (PA) (such as, Polyamide 6 and Polyamide 66) and acetal resins [such as polyoxymethylene (POM) copolymer].

### Composite Polymer Particles

The composite polymer particles may exhibit a multi-domain or composite structure comprising a polyolefin phase or component and an acrylic phase or component, the latter of which is capable of serving as a compatibilizing phase in a host polymer resin or matrix. Examples of multi-domain or composite structures, according to the present invention, include a structure comprising a core and at least one shell or phase around the core, such as a multi-layer structure, a core/shell structure or a core/shell/shell structure, or a multi-lobed structure.

Preferably, the composite structure is a core/shell structure. In a core/shell structure, the core preferably comprises one or more polyolefins, and the (meth)acrylic monomers polymerized onto the polyolefin to form at least a partial shell around the polyolefin core.

The composite polymer particles may contain from 50 to 95 wt % of units derived from an olefin and from 5 to 50 wt % of units derived from (meth)acrylic. All individual values and subranges from 50 to 95 wt % are included herein and disclosed herein; for example, the units derived from olefin may be from an upper limit of 55, 60, 65, 70, 75, 80, 85, 90 or 95 wt % to a lower limit of 50, 55, 60, 65, 70, 75, 80, 85, or 90 wt %. For example, the units derived from olefin may range from 50 to 95 wt %, or in the alternative, the units derived from olefin may range from 60 to 95 wt %, or in the alternative, the units derived from olefin may range from 70 to 90 wt %, or in the alternative, the units derived from olefin may range from 85 to 95 wt %, or in the alternative, the units derived from olefin may range from 65 to 85 wt %. All individual values and subranges from 5 to 50 wt % are included herein and disclosed herein; for example, the units derived from (meth)acrylic may range from an upper limit of 10, 15, 20, 25, 30, 35, 40, 45 or 50 wt % to a lower limit of 5, 10, 15, 20, 25, 30, 35, 40, or 45 wt %. For example, the units derived from (meth)acrylic may range from 5 to 50 wt %, or in the alternative, the units derived from (meth)acrylic may range from 10 to 50 wt %, or in the alternative, the units derived from (meth)acrylic may range from 5 to 40 wt %, or in the alternative, the units derived from (meth)acrylic may range from 5 to 30 wt %, or in the alternative, the units derived from (meth)acrylic may range from 15 to 35 wt %.

The (meth)acrylic component may have a Tg of at least 50° C. All individual values and subranges from at least 50° C. are included herein and disclosed herein. For example, the Tg of the (meth)acrylic component may be from at least 50° C., or in the alternative, the Tg of the (meth)acrylic component may be from at least 50° C., or in the alternative, the Tg of the (meth)acrylic component may be from at least 60° C., or in the alternative, the Tg of the (meth)acrylic component may be from at least 70° C., or in the alternative, the Tg of the (meth)acrylic component may be from at least 80° C. The (meth)acrylic component may have a Tg less than or equal to 120° C. The meth(acrylic) phase may be partially crosslinked.

An impact modifier can be prepared, for example, by isolating or drying the composite polymer particles. As used herein, “isolating” or “drying” refers to a process of removing water from an aqueous composition. Isolation and drying methods include, but are not limited to spray drying, coagulation, and freeze drying.

### Examples

The following examples illustrate the present invention but are not intended to limit the scope of the invention.

Aqueous polyolefin dispersion (POD) samples were produced using a mechanical dispersion process. The fabrication of the POD used in Example 2 is given as a representative example. PODs were prepared using a KWP ZSK25 twin screw extruder (Krupp Werner & Pfleiderer Corp., Ramsey, N.J.) with a 25 mm screw diameter, 60 length to diameter ratio (L/D), and a rotation speed of 450 RPM. ENGAGE™ 8137 Polyolefin Elastomer (60.5 g/min) and RETAIN™ 3000 Polymer Modifier (7.6 g/min) (both obtained from The Dow Chemical Company, Midland, Mich.), were supplied to the feed throat of the extruder via a Schenck MechaTron loss-in-weight feeder and a Schenck volumetric feeder, respectively. The liquid crosslinking coagent, triallyl (iso)cyanurate (TAIL; 1.5 mL/min), was injected into the polymer melt zone using an Isco dual syringe pump (Teledyne Isco, Inc., Lincoln, Nebr. The mixture was melt-blended and emulsified in the presence of an initial aqueous stream containing sodium lauryl ether sulfate (EMPICOL® ESB70; 1.1 g/min, obtained from Huntsman), and sodium oleate solution (Na-Oleate; 2.5 g/min) in 2.6 g water. The Na-Oleate solution was prepared separately by the addition of 50 wt % aqueous NaOH to oleic acid (90% purity, obtained from Fisher Chemical). An excess of 175 mol % NaOH was added relative to the number of mols of oleic acid. After melt-blending and emulsification, the emulsion phase was passed forward to a dilution and cooling zone of the extruder, where additional water (100 g/min) was added to form a dilute aqueous dispersion. Both the initial aqueous stream and the dilution water were delivered by Isco dual syringe pumps, and the barrel temperature of the extruder was set to 140-150° C. Upon exiting the extruder, the dispersion was allowed to cool to room temperature and filtered through a 200 μm nylon mesh filter bag. A total of 3 L of POD was collected. The volume average particle size was determined using a Beckman Coulter LS 13320 Laser Light Scattering Particle Sizer (Fullerton, Calif.). The method assumed a real fluid refractive index=1.332, a real sample refractive index=1.5, and an imaginary sample refractive index=0. POD compositions are shown in Table 1, in which all values are given as weight percent unless otherwise noted. Note that Example 4 was prepared by cold blending two separate PODs prepared by variations to the process described above, whereby one POD was made using EMPICOL® ESB and the other POD was made using K-oleate.

POA samples were produced using an emulsion polymerization process. The fabrication of the POA used in Example 2 is given as a representative example. A sample of POD (1500 g), as described in Table 1, was diluted to approximately 40 wt % solids with deionized water in a 3 L four-neck round-bottom flask outfitted with a condenser, a temperature probe, and a mechanical stirrer. The flask was placed under nitrogen, the stirring rate set to 250 RPM, and the temperature of the dispersion was controlled at 65° C. with a heating mantle. A solution of EDTA was added to the reactor (3.2 mL, 1.0 wt % in water), followed by a solution of FeSO₄·7H₂O (14.7 mL; 0.15 wt % in water). Separately prepared solutions of 70 wt % tert-butyl hydroperoxide (t-BHP; 2.7 g in 50.7 g water) and sodium formaldehydesulfoxylate (SFS; 1.9 g in 50.7 g water) were added to the reactor over 60 min. The reactor contents were then held at 65° C. for 30 min. In a separate glass vessel, a monomer emulsion (M.E.) containing deionized water (66.5 g), sodium dodecyl benzene sulfonate (1.3 g; 22.0 wt % solution in water), butyl acrylate (BA; 3.2 g), and methyl methacrylate (MM; 155.2 g) was prepared. The mass ratio of POD to monomer was 80:20. Solutions of t-BHP (0.5 g in 15.4 g water) and SFS (0.3 g in 15.4 g water) were prepared and loaded into plastic syringes. Feeding of the M.E. and solutions of the redox pair t-BHP/SFS was started simultaneously. The M.E. was fed to the reactor over 60 min, and the redox initiator package was fed over 90 min total (i.e., the redox cofeed continued for 30 min after the M.E. feed was complete). The reactor was then held at 65° C. for 20 min before cooling to room temperature. The resulting sample was filtered through a 100 mesh stainless steel filter.

To measure the grafting efficiency of a given sample (i.e., the extent of association between the POD core and the acrylic phase), a solvent extraction method was performed as disclosed by Carter et al., Design and Fabrication of Polyolefin-Acrylic Hybrid Latex Particles, ACS Appl. Polym. Mater. 2019, 1, 3185-3195. Briefly, a POA sample was added to tetrahydrofuran (THF) and agitated overnight at room temperature (˜1:25 wt:wt POA:THF). The sample was then spiked with an equal volume of acetonitrile (ACN) and centrifuged to isolate the liquid phase. Separately, a GPC calibration curve was constructed from the serial dilution of a known mass of un-crosslinked PMMA latex and the refractive index detector area integration response. For a given POA sample, the area of the peak in the GPC chromatogram corresponding to the ungrafted acrylic polymer was compared to the calibration curve, and subtracted from the known total mass of acrylic in the system, to yield the grafting efficiency. The grafting efficiency determined using this method for the Examples is given in Table 1.

To obtain a dry, powdered POA sample, the following general coagulation procedure was used. A solution of 7.4 g CaCl₂) and 2.2 g concentrated HCl_{(aq)} dissolved in 1800 g deionized water was added to a 4 L glass beaker and heated to 75° C. with stirring. Separately, a POA sample, as described in Table 1, was diluted to ˜30 wt % solids with deionized water. A portion of the diluted POA sample (900 g) was heated to 70° C. with stirring, and then added to the pre-heated solution of CaCl₂/HCl_{(aq)} in water all at once. The resulting mixture was held at 75° C. with stirring for 5 min, and then neutralized to pH˜7 using an aqueous solution of phosphate (8.3 g of monosodium phosphate and 36.7 g of disodium phosphate in 855 g of deionized water). The neutralized mixture was then rapidly heated to 90° C., held at 90° C. for 30 min, and then cooled to 60° C. At 60° C., the reaction mixture was vacuum filtered through a Buchner funnel and Whatman filter paper. The resulting wet filter cake was washed copiously with deionized water, and then dried in a vacuum oven at 60° C. for 24 hr to yield a white powder.

TABLE 1

| | | POD | POA | POA Acrylic | POA Impact |
|---|---|---|---|---|---|
| | | Particle Size | Grafting | Composition | Performance |
| | | (diameter, | Efficiency | (MMA/BA, | (% Ductility, −20° |
| | POD Composition | nm) | (%) | wt:wt) | C./−30° C.) |
| Comparative | 79% ENGAGE ™ 8137 | 347 | 62% | 98:2 | 0/0 |
| Example 1 | 10% RETAIN ™ 3000 | | | | |
| | 5% LICOCENE ™ PE MA 4351 | | | | |
| | 2% TAIC | | | | |
| | 4% SLES (EMPICOL ™ ESB) | | | | |
| Example 1 | 79% ENGAGE ™ 8137 | 405 | 91% | 98:2 | 20/0 |
| | 10% RETAIN ™ 3000 | | | | |
| | 5% LICOCENE ™ PE MA 4351 | | | | |
| | 2% TAIC | | | | |
| | 4% K-Oleate | | | | |
| Example 2 | 80% ENGAGE ™ 8137 | 403 | 93% | 98:2 | 100/40 |
| | 10% RETAIN ™ 3000 | | | | |
| | 5% LICOCENE ™ PE MA 4351 | | | | |
| | 2% TAIC | | | | |
| | 1.5% Na-Oleate | | | | |
| | 1.5% SLES | | | | |
| Example 3 | 79% ENGAGE ™ 8137 | 343 | 90% | 98:2 | 100/0 |
| | 10% RETAIN ™ 3000 | | | | |
| | 5% LICOCENE ™ PE MA 4351 | | | | |
| | 2% TAIC | | | | |
| | 2% Na-Oleate | | | | |
| | 2% SLES | | | | |

### Compounding and Injection Molding Procedure

The grafted polyolefin-acrylic core-shell particles were used as an impact modifier in polycarbonate resin (CALIBRE 200, available from Covestro). The results were compared to the performance of a commercially-available methyl methacrylate-butadiene-styrene (MBS) impact modifier (PARALOID™ EXL 2690, available from The Dow Chemical Company).

Prior to compounding, a sample of PC resin was dried for 2-4 hr at 110° C. in an oven. The PC resin and a pre-determined mass of dry impact modifier (3 or 5 wt % impact modifier, based on total mass) were combined, mixed manually, and compounded using a JSW 28 co-rotating twin screw extruder (L/D=40). The resin and the impact modifier were supplied to the feed throat of the extruder via gravimetric K-Tron feeders and then melt-blended. The extruded sample strand was then cooled in a water trough, passed through an air-knife to remove water on the surface of the strand, and pelletized with a granulometer. The temperature profile of the extruder was set to 260-270-280-285-290° C. (in the direction from the hopper to the die) compounding was performed at a screw speed of 150 rpm with an output of 10 kg/hr.

The resulting compounded PC pellets were dried for 4 hr at 110° C. in a low pressure dryer and subsequently injection molded into a die to yield a dog-bone shape or a rectangular bar, for impact testing, using the following temperature profile: 280-280-285-290° C. (from the hopper to the die).

Test methods shown below include melt flow rate (MFR) as measured according to ISO 1133 and Notched Izod Impact Strength as measured according to ASTM D256. For each method, at least 5 samples were tested.

TABLE 2

| Matrix + Impact | Notched Izod Impact Strength (ft-lbs/in) | | | | |
|---|---|---|---|---|---|
| Modifier (identities | Room | | | | |
| and composition) | Temp | 0° C. | −10° C. | −20° C. | −30° C. |
| CALIBRE 200 + 5% | 13.47 | n/a | 12.57 | 12.16 | 8.751 |
| Example 2 | | | | | |
| CALIBRE 200 + 5% | 13.86 | n/a | 12.58 | 12.12 | 8.416 |
| Example 3 | | | | | |
| CALIBRE 200 + 5% | 12.72 | n/a | 11.15 | 10.59 | 10.073 |
| PARALOID ™ EXL | | | | | |
| 2690 | | | | | |
| CALIBRE 200 + 5% | 11.92 | 11.86 | n/a | 9.41 | 5.000 |
| Comparative | | | | (complete | |
| Example 1 | | | | breaks) | |
| | | | | 10.42 | |
| | | | | (partial | |
| | | | | breaks) | |
| CALIBRE 200 + 5% | 12.08 | 11.86 | n/a | 11.05 | 5.03 |
| Example 4 | | | | | (complete |
| | | | | | breaks) |
| | | | | | 10.22 |
| | | | | | (partial |
| | | | | | breaks) |
| CALIBRE 200 + 5% | 12.34 | 11.66 | n/a | 11.18 | 5.823 |
| Example 3 | | | | | (complete |
| | | | | | breaks) |
| | | | | | 10.3 |
| | | | | | (partial |
| | | | | | break) |

TABLE 3

| | Ductility (% of bars showing ductile break) | | | | |
|---|---|---|---|---|---|
| Matrix + Impact | Room | | | | |
| Modifier | Temp | 0° C. | −10° C. | −20° C. | −30° C. |
| CALIBRE 200 + 5% | 100 | n/a | 100 | 100 | 40 |
| Example 2 | | | | | |
| CALIBRE 200 + 5% | 100 | n/a | 100 | 100 | 0 |
| Example 3 | | | | | |
| CALIBRE 200 + 5% | 100 | n/a | 100 | 100 | 40 |
| PARALOID ™ EXL | | | | | |
| 2690 (Control) | | | | | |
| CALIBRE 200 + 5% | 100 | 100 | n/a | 0 | 0 |
| Comparative | | | | (complete | |
| Example 1 | | | | breaks) | |
| | | | | 80 | |
| | | | | (partial | |
| | | | | breaks) | |
| CALIBRE 200 + 5% | 100 | 100 | n/a | 100 | 0 |
| Example 4 | | | | | (complete |
| | | | | | breaks) |
| | | | | | 20 |
| | | | | | (partial |
| | | | | | breaks) |
| CALIBRE 200 + 5% | 100 | 100 | n/a | 100 | 0 |
| Example 3 | | | | | (complete |
| | | | | | breaks) |
| | | | | | 40 |
| | | | | | (partial |
| | | | | | break) |

TABLE 4

| Matrix + Impact | |
|---|---|
| Modifier | MFR (1.2 kg @ 300° C.) |
| CALIBRE 200 + | 16.2 |
| 5% Example 2 | |
| (coagulated) | |
| CALIBRE 200 + | 16.2 |
| 5% Example 3 | |
| (coagulated) | |
| CALIBRE 200 + | 15.0 |
| 5% PARALOID ™ | |
| EXL 2690 | |
| CALIBRE 200 + | 16.2 |
| 5% Comparative | |
| Example 1 | |
| CALIBRE 200 + | 16.6 |
| 5% Example 4 | |
| (coagulated) | |
| CALIBRE 200 + | 16.2 |
| 5% Example 3 | |

### Test Methods

Test methods include the following:

Density of ethylene-based polymers measured according to ISO 1183.

Density of propylene-based polymers measured according to ASTM D792.

MFR measured according to ISO 1133.

Notched Izod Impact Strength measured according to ASTM D256

The present invention may be embodied in other forms without departing from the spirit and the essential attributes thereof, and, accordingly, reference should be made to the appended claims, rather than to the foregoing specification, as indicating the scope of the invention.

1. A composite polymer composition comprising:
the emulsion polymerization product of:
(i) an aqueous polyolefin dispersion comprising the melt kneading product of one or more polyolefins, from 0.5 to 25 wt % of one or more dispersion stabilizing agents, water, and optionally a neutralizing agent, and
(ii) one or more (meth)acrylic monomers;
wherein the one or more polyolefins have a Tg equal to or less than 50° C.;
wherein the melt kneading product (i) comprises polymer particles having a volume average particle size between 50 nm and 2000 nm dispersed in the water;
wherein the one or more dispersion stabilizing agents comprises a fatty acid or fatty acid salt stabilizing agent; and
wherein the one or more (meth)acrylic monomers graft onto the polymer particles form composite polymer particles,

2. The composite polymer composition according to claim 1, wherein the fatty acid or fatty acid salt stabilizing agent comprises 8 to 28 carbon atoms.

3. The composite polymer composition according to claim 2, wherein the fatty acid or fatty acid salt stabilizing agent comprises 12 to 24 carbon atoms.

4. The composite polymer composition according to claim 3, wherein the fatty acid or fatty acid salt stabilizing agent comprises 16, 18, or 20 carbon atoms.

5. The composite polymer composition according to claim 4, wherein the fatty acid or fatty acid salt stabilizing agent comprises stearic acid, oleic acid, or linoleic acid, or a salt thereof.

6. The composite polymer composition according to claim 1, wherein the one or more dispersion stabilizing agents further a mixture of at least two dispersion stabilizing agents.

7. The composition polymer composition according to claim 1, wherein the composite polymer particles have a grafting efficiency of at least 80%.

8. The composite polymer composition according to claim 1, wherein the ratio of polyolefin to poly(meth)acrylic is between 60:40 and 95:5

9. The composite polymer composition according to claim 1, wherein the one or more polyolefins are selected from the group consisting of ethylene homopolymers, ethylene/α-olefin copolymers, ethylene/α-olefin multiblock interpolymers, propylene homopolymers, propylene/α-olefin copolymers and propylene/α-olefin multiblock interpolymers.

10. The composite polymer composition according to claim 1, wherein the one or more (meth)acrylic monomers are selected from the group consisting of functionalized (meth)acrylic monomers.

11. The composite polymer composition according to claim 1, wherein the composite polymer particles have a core/shell or core/partial shell structure.

12. The composite polymer composition according to claim 1, wherein the (meth)acrylic shell is partially crosslinked and has a Tg greater than or equal to 50° C.

13. An impact modifier composition comprising
a dried product of the composite polymer composition according to claim 1.

14. An impact modified resin comprising:
a matrix polymer resin; and
the impact modifier composition according to claim 10.

15. A method for forming an impact modifier composition comprising:
melt kneading one or more polyolefins, one or more dispersion stabilizing agents, water and optionally a neutralizing agent, wherein the one or more polyolefins have a Tg of equal to or less than 50° C., and wherein the one or more dispersion stabilizing agents comprise an fatty acid or fatty acid salt stabilizing agent;
adding to the melt kneading product one or more (meth)acrylic monomers under emulsion polymerization conditions to form a composite polymer composition; and
isolating the composite polymer particles by removing water from the emulsion,
wherein the isolating is selected from the group consisting of spray drying, coagulation, and freeze drying.
